(19) United States
(12) Patent Application Publication
(10) Pub. No.: US 2018/0024904 A1
(43) Pub. Date: Jan. 25, 2018

(54) TEST SUPPORT DEVICE AND TEST SUPPORT METHOD

(71) Applicant: FUJITSU LIMITED, Kawasaki-shi (JP)

(72) Inventors: Hideki Gou, Numazu (JP); Atsushi Kaneko, Kani (JP); Seiya Shindo, Yokohama (JP); Eiji Mizunuma, Yokohama (JP); Kazutaka Taniguchi, Yokohama (JP); Yasuhiro Suzuki, Yokohama (JP)

(73) Assignee: FUJITSU LIMITED, Kawasaki-shi (JP)

(21) Appl. No.: 15/628,795

(22) Filed: Jun. 21, 2017

(30) Foreign Application Priority Data
Jul. 21, 2016 (JP) 2016-143779

(51) Int. Cl. G06F 11/34; G06F 9/50

(52) U.S. Cl. CPC G06F 11/3414; G06F 11/3495; G06F 9/5044; G06F 11/3688

(57) ABSTRACT

A test support device includes a processor configured to acquire event information on events which occur during an execution of a target program. The processor is configured to classify the events into event groups on basis of similarity of timings at which the respective events occur. The processor is configured to calculate, for each of the event groups, a summed value of evaluation values of the respective events classified into the relevant event group. The processor is configured to determine for each of the event groups, on basis of the summed value, whether a breakpoint of a target process executed by the target program is present at a timing corresponding to the relevant event group. The processor is configured to display timing information indicating a timing at which a breakpoint is determined to be present, in association with elapsed time after a start of executing the target program.

### CROSS-REFERENCE TO RELATED APPLICATION

This application is based upon and claims the benefit of priority of the prior Japanese Patent Application No. 2016-143779, filed on Jul. 21, 2016, the entire contents of which are incorporated herein by reference.

### FIELD

The embodiment discussed herein is related to a test support device and a test support method.

### BACKGROUND

Conventionally, a technology relating to a test performed for an information processing system has existed.

For example, a test method has been suggested which determines a fluctuation pattern of a load for each component included in a hardware configuration of a target device, and operates each hardware component along with the determined fluctuation pattern so as to check whether the operation of each hardware component is normal.

In addition, a verification method has been suggested which sets a pattern of an execution order that may be statically analyzed based on, for example, a source code or design information of a program.

Further, a method has been suggested in which, based on the number of same-timing variation patterns existing among test items, a related test item is presented.

Related technologies are disclosed in, for example, Japanese Laid-Open Patent Publication No. 2012-174092, Japanese Laid-Open Patent Publication No. 11-242614, and Japanese Laid-Open Patent Publication No. 2013-142967.

### SUMMARY

According to an aspect of the present invention, provided is a test support device including a memory and a processor coupled to the memory. The processor is configured to acquire event information on events which occur during an execution of a target program to be tested. The processor is configured to classify the event information into event groups on basis of similarity of timings at which the respective events occur. The processor is configured to calculate, for each of the event groups, a summed value of evaluation values of the respective events classified into the relevant event group. The processor is configured to determine for each of the event groups, on basis of the summed value, whether a breakpoint of a target process is present at a timing corresponding to the relevant event group. The target process is executed by the target program. The processor is configured to display timing information indicating a timing at which a breakpoint is determined to be present, in association with elapsed time after a start of executing the target program.

The object and advantages of the disclosure will be realized and attained by means of the elements and combinations particularly pointed out in the claims. It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating an example of a timing test;

FIG. 2 is a diagram illustrating an exemplary method of identifying process breakpoints to perform a timing test;

FIG. 3 is a diagram illustrating a configuration of a test support system according to an embodiment;

FIG. 4 is a diagram illustrating a functional configuration of a test support device according to the embodiment;

FIG. 5 is a diagram illustrating an example of data stored in a process result storage unit;

FIG. 6 is a diagram illustrating generation of process breakpoints;

FIG. 7 is a diagram illustrating evaluation values assigned to change points serving as candidates for a process breakpoint, and an integrated value thereof;

FIG. 8 is a diagram illustrating an example of data stored in a breakpoint storage unit;

FIG. 9 is a diagram illustrating levels for a process breakpoint and breakpoints generated depending on the levels;

FIG. 10 is a diagram illustrating a relationship of the levels for a process breakpoint, accuracy of a breakpoint, and the number of executions of the timing test;

FIG. 11 is a diagram illustrating an example of the number of executions of the timing test depending on the levels for a process breakpoint;

FIG. 12 is a diagram illustrating a configuration of a computer that functions as the test support device according to the embodiment; and

FIG. 13 is a flowchart illustrating an exemplary test process according to the embodiment.

### DESCRIPTION OF EMBODIMENT

An example of a system test is a timing test in which, by considering a program as an information processing system, a test is performed from the viewpoint of a user.

The timing test subdivides a process executed by the information processing system into process units each having a specific meaning, and executes the subdivided processes once or more times in combination with another operation so as to check whether there is a problem in a result.

For example, when a process of the information processing system is subdivided into several processes including a pre-process, a reception process, a conversion process, a transmission process, and a post-process, a test needs to be performed at least once for each of the processes.

Unlike a test by a system developer of an information processing system, the timing test is performed in a state where breakpoints (process breakpoints) of processes in the information processing system are unidentified. Hence, the timing test is performed in the manner that a test person repeatedly performs a test many times while delaying the timings.

Since a test is repeatedly performed, and it is necessary to check test results obtained from the repetition of the test, a lot of time and efforts are required. Therefore, the timing test may not be effectively performed.

Hereinafter, an embodiment will be described in detail with reference to the drawings.

Prior to the description, process breakpoints for a timing test will be described first.

A timing test is known in which a test is performed from the viewpoint of a user for a program executed by an information processing system.

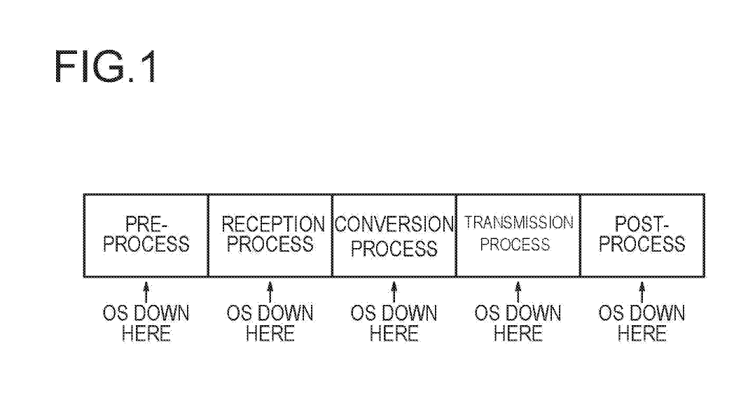

FIG. 1 illustrates an example of the timing test. As illustrated in FIG. 1, for example, when a pre-process, a reception process, a conversion process, a transmission process, and a post-process exist as processes of a program in an information processing system, a test needs to be performed at least once for each of the processes, in the timing test. In the example illustrated in FIG. 1, for example, an operating system (OS) down test is performed once for each of the processes.

Here, the following simple method may be taken into account as an exemplary method of determining a timing for performing the timing test.

First, a test person who is in charge of the test causes the information processing system to execute a program to be tested and subdivides the process of the program by using information such as a message, file presence/absence, and performance information that may be observable during the process. The observable performance information is, for example, a central processing unit (CPU) usage rate, a memory usage rate, and the number of disk inputs/outputs (IOs).

The test person determines a timing when a change occurs in behaviors of the message, the file presence/absence, and the performance information, as a process breakpoint of the program. In this case, the test person identifies the breakpoint of the process by using the following information.

In identifying a breakpoint by the message, information of a system log is used. Since the system log includes messages such as “Starting/Stopping XXX Process” and “Starting/Stopping File Transmission”, the test person determines a timing when a new message is included in the system log, as a change point of the information of the system log. Then, the test person identifies the change point as a process breakpoint.

In identifying a breakpoint by the file presence/absence, information acquired by a file list display command is used. For example, a test person executes a file list display command and determines, for example, a timing when a creation of a file is started or a deletion of a file is completed, as a change point of the file presence/absence. Then, the test person identifies the change point as a process breakpoint.

In identifying a breakpoint by the CPU usage rate, a breakpoint is determined by a change of the CPU usage rate. For example, a test person identifies a change point at which a value of the CPU usage rate changes, as a process breakpoint.

In identifying a breakpoint by the memory usage rate, a breakpoint is determined by a change of the memory usage rate. For example, a test person identifies a change point at which a value of the memory usage rate changes, as a process breakpoint.

In identifying a breakpoint by the number of disk IOs, a breakpoint is determined by a change of the number of disk IOs. For example, a test person identifies a change point at which a value of the number of disk IOs changes, as a process breakpoint.

In this way, a test person may identify a process breakpoint by using information such as the message, the file presence/absence, and the performance information such as the CPU usage rate, the memory usage rate, and the number of disk IOs.

To summarize the above-described simple method, a breakpoint is identified as follows:

(1) All change points during processes of a program are regarded as breakpoints.

(2) Based on a change point of the performance information, even when a change amount of the performance information is small, the change point is regarded as a breakpoint.

(3) The message, the file presence/absence, and the performance information are equally treated, even though degrees of accuracy for breakpoints are different from each other.

However, the above-described simple method may not identify a breakpoint of a meaningful process unit because the criteria of a threshold value for determining a process breakpoint on the basis of the message, the file presence/absence, and the performance information is unclear. Further, since all change points are identified as process breakpoints, the number of breakpoints increases and the number of executions of the timing test increases. Accordingly, the test time for the timing test increases and as a result, undue efforts are caused.

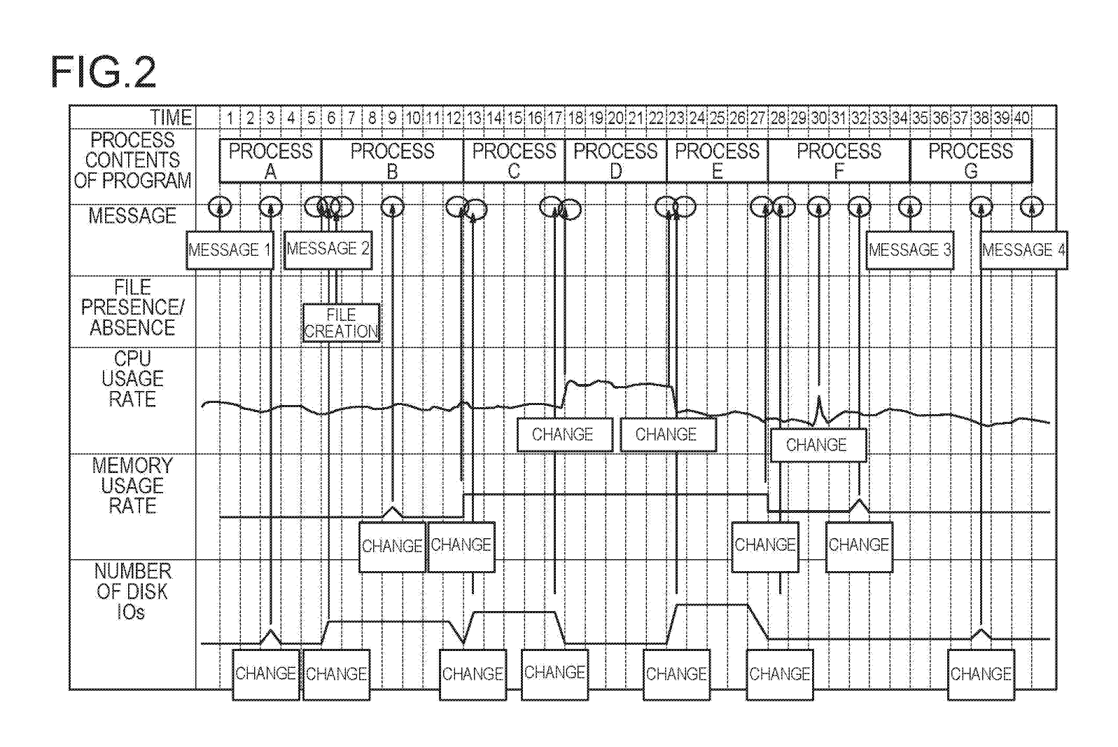

FIG. 2 illustrates process breakpoints obtained by using the above-described simple method. In FIG. 2, the horizontal axis direction indicates time, and the vertical axis direction indicates process contents of a program, a message, file presence/absence, a CPU usage rate, a memory usage rate, and the number of disk IOs. In the example illustrated in FIG. 2, a case where processes A to G exist as process contents of a program will be described. As illustrated in FIG. 2, timings of outputting messages 1 to 4 indicated by information of a system log, a timing of a file creation indicated by information acquired by a file list display command, and timings of changes in values of performance information are determined as change points, and the change points are identified as process breakpoints. Thus, the number of process breakpoints becomes enormous thereby increasing the number of executions of the timing test.

Accordingly, in the present embodiment, the accuracy for identifying a meaningful process breakpoint is improved by adding two viewpoints of an “importance degree of information” and a “a threshold value of a change rate of performance information” to the above-described simple method. Further, accuracy of a breakpoint is displayed with a numerical value so as to display which level of a timing test is to be performed, to a test person and enable the test person to select a level of a breakpoint.

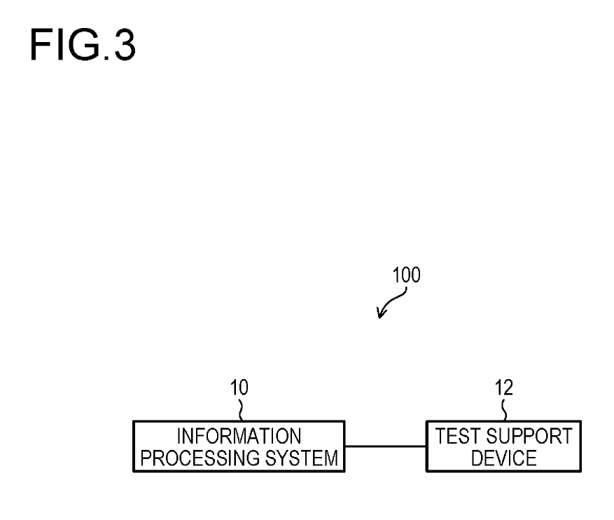

As illustrated in FIG. 3, a test support system 100 according to the present embodiment includes an information processing system 10 and a test support device 12. The information processing system 10 and the test support device 12 are coupled to each other via a communication line such as a local area network (LAN).

The information processing system 10 is a test target system to be subject to the timing test. In the information processing system 10, a test target program to be subject to the timing test is executed.

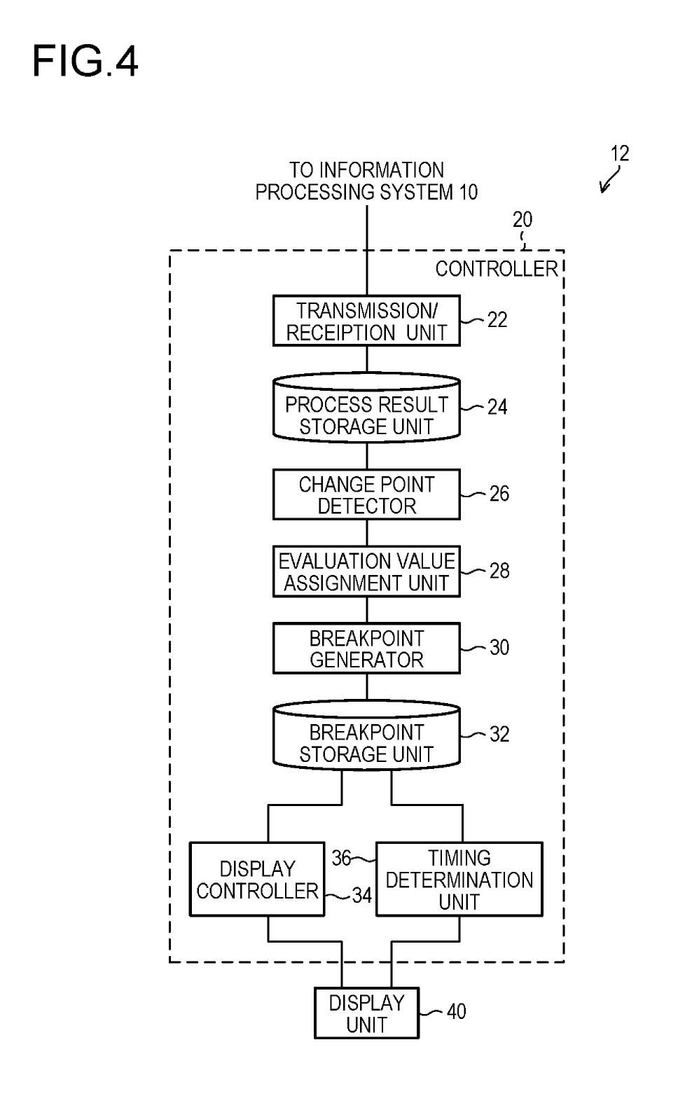

The test support device 12 causes the information processing system 10 to execute the test target program and detects events occurring in processes of the program to generate process breakpoints on the basis of detection results. As illustrated in FIG. 4, the test support device 12 includes a controller 20 and a display unit 40.

As illustrated in FIG. 4, the controller 20 includes a transmission/reception unit 22, a process result storage unit 24, a change point detector 26, an evaluation value assignment unit 28, a breakpoint generator 30, a breakpoint storage unit 32, a display controller 34, and a timing determination unit 36.

The transmission/reception unit 22 performs transmission/reception of information with the information processing system 10. Specifically, the transmission/reception unit 22 receives process results of the test target program, which is transmitted from the information processing system 10. The transmission/reception unit 22 stores the process results of the test target program in the process result storage unit 24. The transmission/reception unit 22 is an example of an acquisition unit of the present embodiment.

In the present embodiment, descriptions will be made on a case where the transmission/reception unit 22 stores information indicating output of a message, file creation, a CPU usage rate, a memory usage rate, and the number of disk IOs at each predetermined timing, as process results in the process result storage unit 24.

The message is obtained from information stored in a system log of the information processing system 10 and included as a message of, for example, “Starting/Stopping XXX Process” or “Starting/Stopping File Transfer” in the system log. Information of the file creation is acquired by, for example, a file list display command and obtained as information representing a timing when the creation of a file is started or the deletion of a file is completed. The CPU usage rate, the memory usage rate, and the number of disk IOs are acquired from a performance log output during the execution of the program in the information processing system 10.

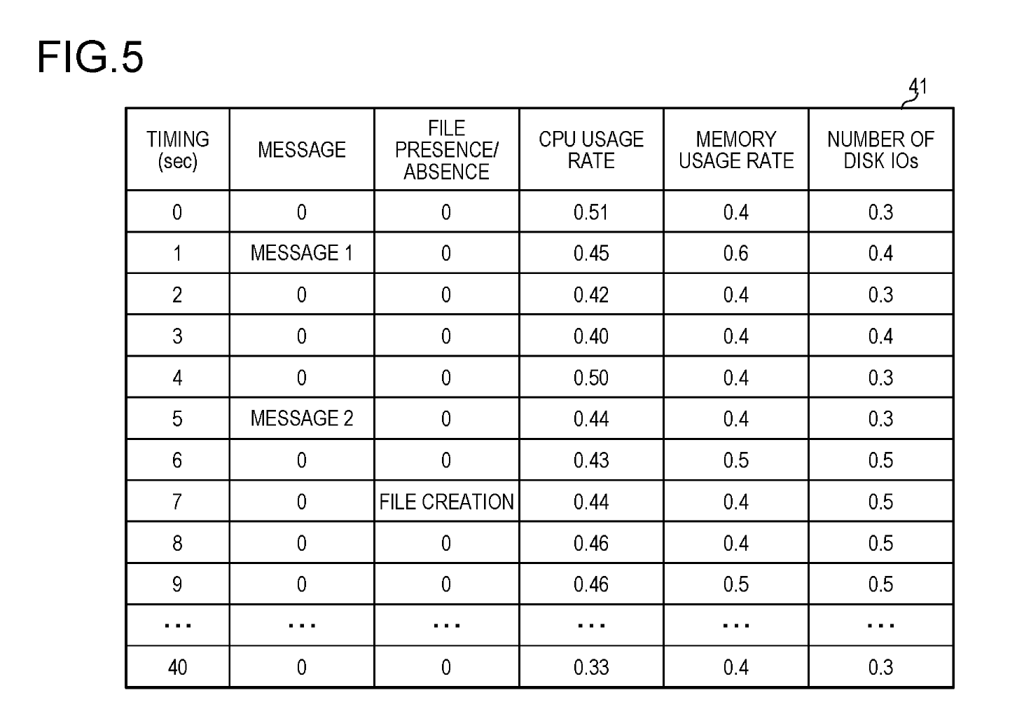

The transmission/reception unit 22 sequentially records each of the plurality of types of process results obtained in the information processing system 10 in a process result table 41 stored in the process result storage unit 24 in association with a timing. FIG. 5 illustrates an example of the process result table 41. In the present embodiment, an example where the processing results are recorded for every one second will be described. The process results are an example of information on events in the present embodiment.

In the example of the process result table 41 illustrated in FIG. 5, “Message 1” is recorded at timing 1 (sec). “Message 2” is recorded at timing 5 (sec). Further, “File Creation” is recorded at timing 7 (sec).

In addition, the CPU usage rate, the memory usage rate, and the number of disk IOs are sequentially recorded in the process result table 41 illustrated in FIG. 5. Here, the number of the disk IOs is converted in accordance with a predetermined calculation so as to fall into a range from 0 to 1.

Based on the process results stored in the process result storage unit 24, the change point detector 26 detects the change points corresponding to a plurality of events occurring in the processes of the test target program. The change points are candidates for process breakpoints of the test target program. The detection of the change points is an example of a detection of events in the present embodiment.

In the present embodiment, descriptions will be made on a case where two types of change points are detected from the process results of the test target program. The first type of change points is a change point related to an event on process contents corresponding to the message output or the file creation. The second type of change points is a change point related to an event on performances, which indicates, for example, a change in the CPU usage rate, a change in the memory usage rate, and a change in the number of disk IOs.

A change point related to an event on process contents has a high accuracy to be a process breakpoint. Meanwhile, a change point related to an event on performances has a low accuracy to be a process breakpoint, as compared with the change point related to an event on process contents.

According to the present embodiment, the value of a change rate of performance information at an occurrence timing of an event on process contents is set as a threshold value of a change point related to an event on performances. In the present embodiment, a change amount of performance information per unit time is defined as the change rate, as represented by the following equation.

Change Rate=Change Amount of Performance Information/Unit Time

For example, when the CPU usage rate is taken into account as performance information, the change amount of the CPU usage rate per unit time is the change rate.

Accordingly, the change point detector 26 first sets a change rate of performance information at an occurrence timing of an event on process contents, as a threshold value of a change point related to an event on performances.

When there exist a plurality of values for a change rate of performance information at an occurrence timing of an event on process contents, an average value of the plurality of values is calculated as a threshold value of a change point. Alternatively, when there exist a plurality of values for a change rate of performance information, a maximum or minimum one of the plurality of values may be set as a threshold value of a change point.

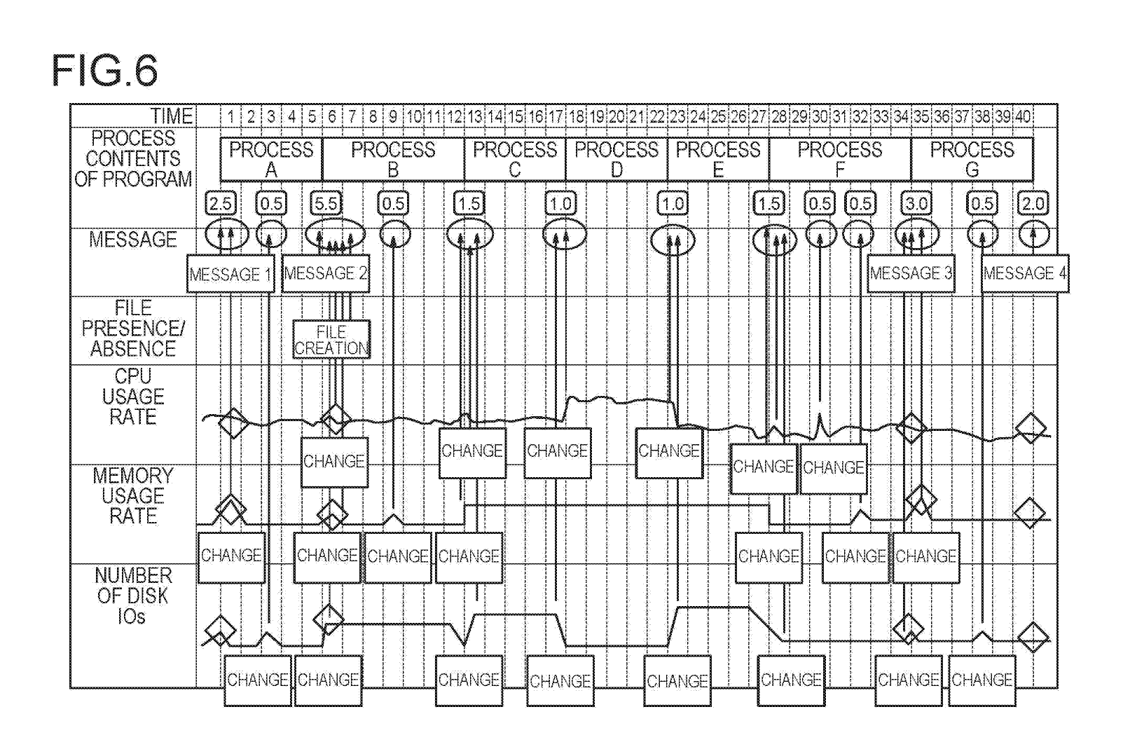

FIG. 6 illustrates generation of process breakpoints. In FIG. 6, the horizontal axis direction indicates time, and the vertical axis direction indicates process contents of the program, the message, the file presence/absence, the CPU usage rate, the memory usage rate, and the number of disk IOs.

In the example illustrated in FIG. 6, processes A to G exist as process contents of the program. In FIG. 6, output of “Message 1”, “Message 2”, “Message 3”, and “Message 4” occur as events corresponding to the message output. In addition, “File Creation” occurs as an event corresponding to the file creation. In FIG. 6, an area surrounded by a diamond represents a change of the CPU usage rate, the memory usage rate, or the number of disk IOs at the occurrence timing of each of the events on process contents.

For example, in the example illustrated in FIG. 6, as events on process contents, the events of the message output are present at four locations, and the event of the file creation is present at one location. Thus, the change point detector 26 calculates an average of the change rates of each of the CPU usage rate, the memory usage rate, and the number of disk IOs at timings corresponding to the occurrence timings of the events of the message output and the file creation. Then, the change point detector 26 sets the average calculated for each of the CPU usage rate, the memory usage rate, and the number of disk IOs, as a threshold value of a change point related to an event on performances.

Next, the change point detector 26 detects a change point on the basis of a type of events and the set threshold value of a change point.

Specifically, for an event on process contents, it is regarded that, in the process results of the program stored in the process result storage unit 24, an event representing a process result on process contents occurs at a timing associated with the process result. Thus, the change point detector 26 detects the occurrence timing of the corresponding event as a change point related to an event on process contents.

For an event on performances, on the basis of each of the values of the performance information included in the process results stored in the process result storage unit 24, it is regarded that, when a change rate of performance information is equal to or more than the set threshold value, an event on performances occurs. Thus, the change point detector 26 detects the occurrence timing of the corresponding event as a change point related to an event on performances.

For example, in the example illustrated in FIG. 6, the change point detector 26 detects the occurrence timings of the events of outputting “Message 1”, “Message 2”, “Message 3”, and “Message 4” and the event of “File Creation” as change points of events on process contents. In addition, in the example illustrated in FIG. 6, it is assumed that, in each of the process results of the performance information, a location indicated by “Change” is a location where a change rate of performance information is equal to or more than the set threshold value. In this case, the corresponding location is detected as a change point related to an event on performances. In the example illustrated in FIG. 6, locations pointed by arrows are the change points.

Based on the events corresponding to the change points detected by the change point detector 26, the evaluation value assignment unit 28 assigns, to each of the change points, an evaluation value preset in accordance with the type of events.

As described above, a change point related to an event on process contents has a relatively high accuracy to be a process breakpoint. Meanwhile, a change point related to an event on performances has a relatively low accuracy to be a process breakpoint, as compared with a change point related to an event on process contents.

Hence, according to the present embodiment, the evaluation value is set in consideration of a difference of importance between a change point related to an event on process contents and a change point related to an event on performances. By assigning an evaluation value in consideration of a difference of importance depending on the type of events corresponding to each of the change points, the accuracy to be a process breakpoint may be improved.

According to the present embodiment, since a change point related to an event on process contents has a high accuracy for a breakpoint, as compared with a change point related to an event on performances, an evaluation value is assigned according to the type of events as follows.

(1) Message output: An evaluation value of 2.0 is assigned.

(2) File Creation: An evaluation value of 2.0 is assigned.

(3) Change of Performance Information (CPU usage rate, memory usage rate, and the number of disk IOs): An evaluation value of 0.5 is assigned.

Based on the timings corresponding to the change points detected by the change point detector 26, the breakpoint generator 30 integrates the change points within a predetermined time period. Then, based on the evaluation values assigned to the respective change points by the evaluation value assignment unit 28, the breakpoint generator 30 generates an integrated value corresponding to the time period and associates the integrated value with a representative timing within the time period. That is, the breakpoint generator 30 classifies the change points into one or a plurality of event groups depending on similarity in the occurrence timings of the change points. The breakpoint generator 30 calculates, for the one or each of the plurality of event groups, an integrated value of the evaluation values corresponding to the respective events classified into the relevant event group. Then, the breakpoint generator 30 associates the integrated value with a representative timing within the event group. The breakpoint generator 30 is an example of a calculator and a determination unit in the present embodiment. The integrated value is an example of a summed value in the present embodiment.

Specifically, when a plurality of change points are present at consecutive timings within a predetermined time period, the breakpoint generator 30 integrates evaluation values assigned to the change points present within the time period so as to generate an integrated value corresponding to the time period. For example, a case where the predetermined time period is 3 seconds will be described. In this case, with respect to each timing of t (second), the breakpoint generator 30 first detects locations where a plurality of change points are present between t (second) and t+1 (second) and the change points are present at each timing. When a plurality of change points are present between t (second) and t+1 (second), the breakpoint generator 30 integrates evaluation values of events corresponding to the plurality of change points present at t (second), t+1 (second), and t+2 (second) so as to generate an integrated value. After generating the integrated value corresponding to t (second), t+1 (second), and t+2 (second), the breakpoint generator 30 starts the next process from the timing of t+3 (second). Hence, once an evaluation value is integrated in an integrated value, the evaluation value is not subject to integration in subsequent processes, and an evaluation value that is not integrated is subject to the integration in subsequent processes. When a plurality of change points are not present between t (second) and t+1 (second), the breakpoint generator 30 generates an evaluation value of an event corresponding to a change point present at t (second) as an integrated value.

For example, change points are present at consecutive 3-second timings (timings 5, 6, and 7) in the location of “Message 2” illustrated in FIG. 6. In this case, since a plurality of change points are present between timings 5 and 6, the breakpoint generator 30 integrates evaluation values of events corresponding to the plurality of change points present at timings 5, 6, and 7 so as to generate an integrated value of 5.5, and associates the integrated value with the change point of the representative timing (e.g., the timing 6).

In addition, since only one change point is present at, for example, the locations of timings 3 and 4 illustrated in FIG. 6, the breakpoint generator 30 generates an evaluation value of 0.5 for an event corresponding to the change point present at the timing 3, as an integrated value. Then, the breakpoint generator 30 associates the integrated value of 0.5 with the change point of the representative timing (e.g., the timing 3).

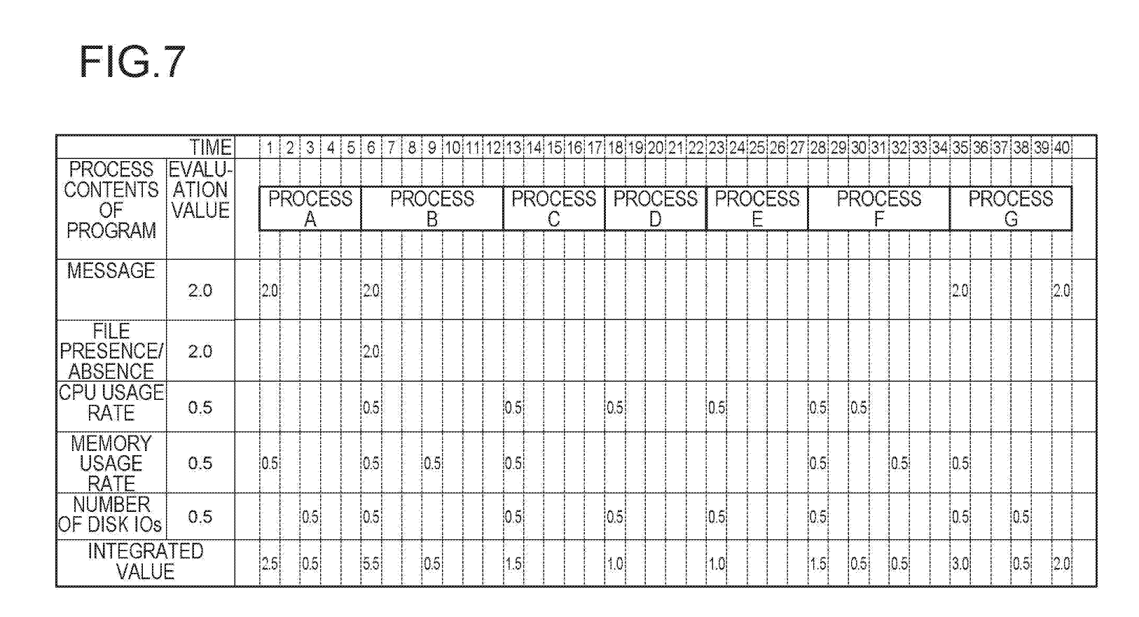

FIG. 7 illustrates the integration of evaluation values assigned to change points. FIG. 7 represents an example of an integrated value obtained from the evaluation values assigned to the change points in FIG. 6. As illustrated in FIG. 7, the evaluation values of the change points are integrated so as to generate an integrated value.

Then, based on the generated integrated value, the breakpoint generator 30 determines whether a process breakpoint of a process executed by the program is present at a timing of each of the event groups, and generates a process breakpoint of the test target program. Specifically, for each of a plurality of levels for a process breakpoint, the breakpoint generator 30 generates a process breakpoint of the test target program on the basis of the generated integrated value and the plurality of levels for a process breakpoint. The levels for a process breakpoint are preset depending on the size of the integrated value. For example, assuming that the plurality of levels for a process breakpoint are levels 1 to 4, the levels are set as indicated in (A) to (D) below.

(A) Level 1: Integrated value of 2.0 or more

(B) Level 2: Integrated value of 1.5 or more

(C) Level 3: Integrated value of 1.0 or more

(D) Level 4: Integrated value of 0.5 or more

Based on the generated integrated value and the levels for a process breakpoint, the breakpoint generator 30 generates, as a breakpoint, a change point related to an integrated value which is equal to or more than a value set as one of the levels. When a plurality of change points are present between t (second) and t+1 (second), and evaluation values of events corresponding to the plurality of change points are integrated so that an integrated value is generated, a change point related to a representative timing is generated as a breakpoint.

The breakpoint generator 30 may use a level selected by a user via an operation unit (not illustrated) from the plurality of levels for a process breakpoint, and generate a change point related to an integrated value which is equal to or more than a value set as the corresponding level, as a breakpoint.

The breakpoint storage unit 32 stores therein each of the breakpoints generated by the breakpoint generator 30. The breakpoint storage unit 32 stores therein the levels for a process breakpoint in association with the breakpoints generated depending on the levels.

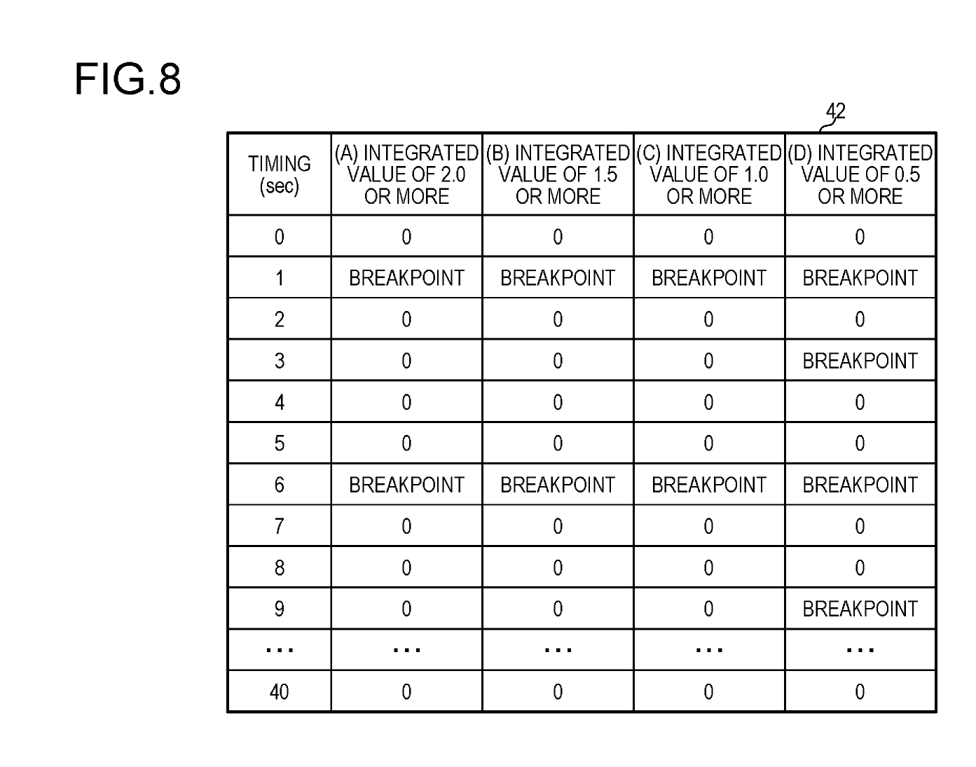

FIG. 8 illustrates an example of the breakpoint table 42 stored in the breakpoint storage unit 32. As illustrated in FIG. 8, the breakpoint table 42 stores the levels for a process breakpoint and the breakpoints generated depending on the levels in association with each other.

As illustrated in the breakpoint table 42 of FIG. 8, different breakpoints are generated depending on the levels for a process breakpoint.

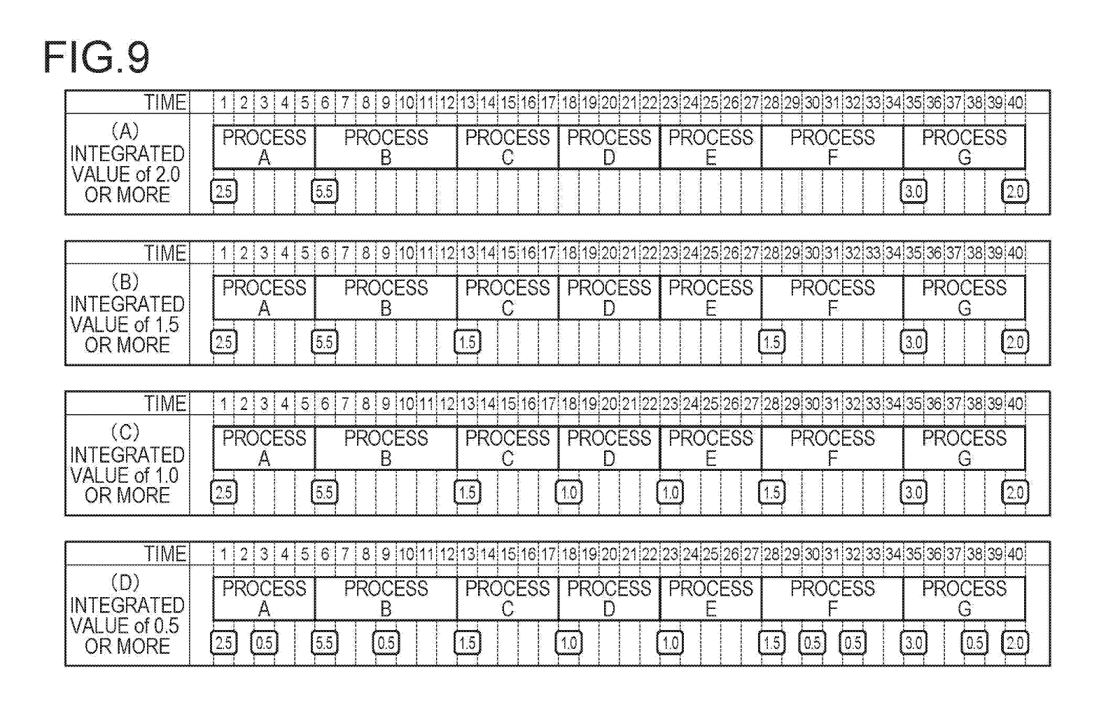

FIG. 9 illustrates breakpoints generated depending on the levels for a process breakpoint, which are sequentially arranged, for each of the levels. In FIG. 9, a square box storing a numeral therein indicates a breakpoint, and the numeral in the square box indicates an integrated value. As illustrated in FIG. 9, different breakpoints are generated depending on the levels for a process breakpoint.

The display controller 34 causes the display unit 40 to display information representing the breakpoints stored in the breakpoint storage unit 32 in association with information representing elapsed time after the start of the process of the test target program. Specifically, when the timings of the respective event groups include a timing when a breakpoint is determined to be present, the display controller 34 causes information representing the timing when a breakpoint is determined to be present to be displayed in association with elapsed time after the start of executing the test target program. The display controller 34 causes the display unit 40 to display, for example, the screen illustrated in FIG. 9. Since a process breakpoint is unidentified yet, the blocks of the processes A to G in FIG. 9 are not displayed.

The timing determination unit 36 subdivides the process of the test target program into a plurality of blocks on the basis of the process breakpoints stored in the breakpoint storage unit 32. Then, the timing determination unit 36 determines a timing for executing a process different from the process of the test target program, depending on start and end timings of each of the plurality of blocks. An example of the process different from the process of the test target program may be a test for each process in the timing test.

For example, the timing determination unit 36 determines a timing such that an OS down test is performed once between the start and the end of each of the plurality of blocks.

The display unit 40 displays information representing a breakpoint associated with information representing elapsed time after the start of the process of the test target program. When a breakpoint is generated by the breakpoint generator 30 on the basis of the integrated value which is equal to or more than a value set as a level selected by a user, the breakpoint corresponding to the selected level is displayed. Further, the display unit 40 displays a timing for performing the test, which is determined by the timing determination unit 36.

The test person considers the method of performing the timing test on the basis of the information displayed in the display unit 40. For example, the test person selects in which level of a breakpoint the test is to be performed, in consideration of a purpose, a time period, and others of the test. When desiring to use a breakpoint with a high accuracy, the test person may select a level corresponding to a large integrated value. When desiring to perform the timing test without omission, the test person may select a level corresponding to a small integrated value.

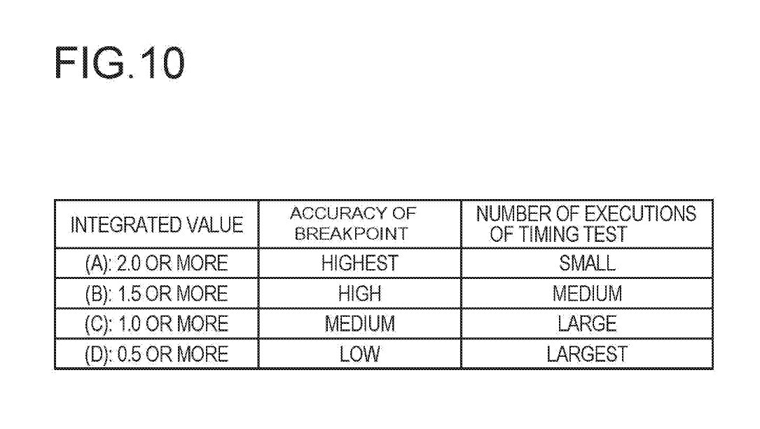

FIG. 10 illustrates a relationship of the levels for a process breakpoint, the accuracy of a breakpoint, and the number of executions of the timing test.

As illustrated in FIG. 10, when the level for a process breakpoint is level A, that is, when the change point of which an integrated value is equal to or more than 2.0 is generated as a breakpoint, only breakpoints in the level with the highest accuracy are generated. Thus, the number of breakpoints decreases, and the number of executions of the timing test in respective processes decreases. Meanwhile, when the level for a process breakpoint is level D, that is, when the change point of which an integrated value is equal to or more than 0.5 is generated as a breakpoint, a breakpoint with a low accuracy is also generated. Thus, the number of breakpoints increases, and the number of executions of the timing test in respective processes becomes the largest.

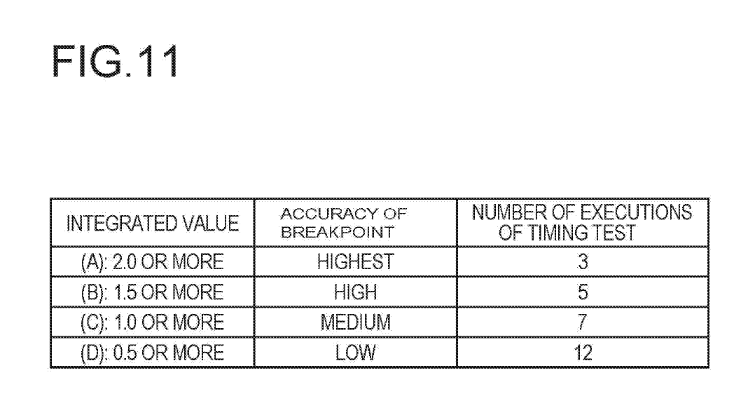

FIG. 11 illustrates a case where the example illustrated in FIG. 9 is applied to FIG. 10. As illustrated in FIG. 11, for example, when the level for a process breakpoint is level A, the process breakpoints are present at four locations, and thus, the number of executions of the timing test in the respective processes is 3. When the level for a process breakpoint is level D, the process breakpoints are present at 13 locations, and thus, the number of executions of the timing test in the respective processes is 12.

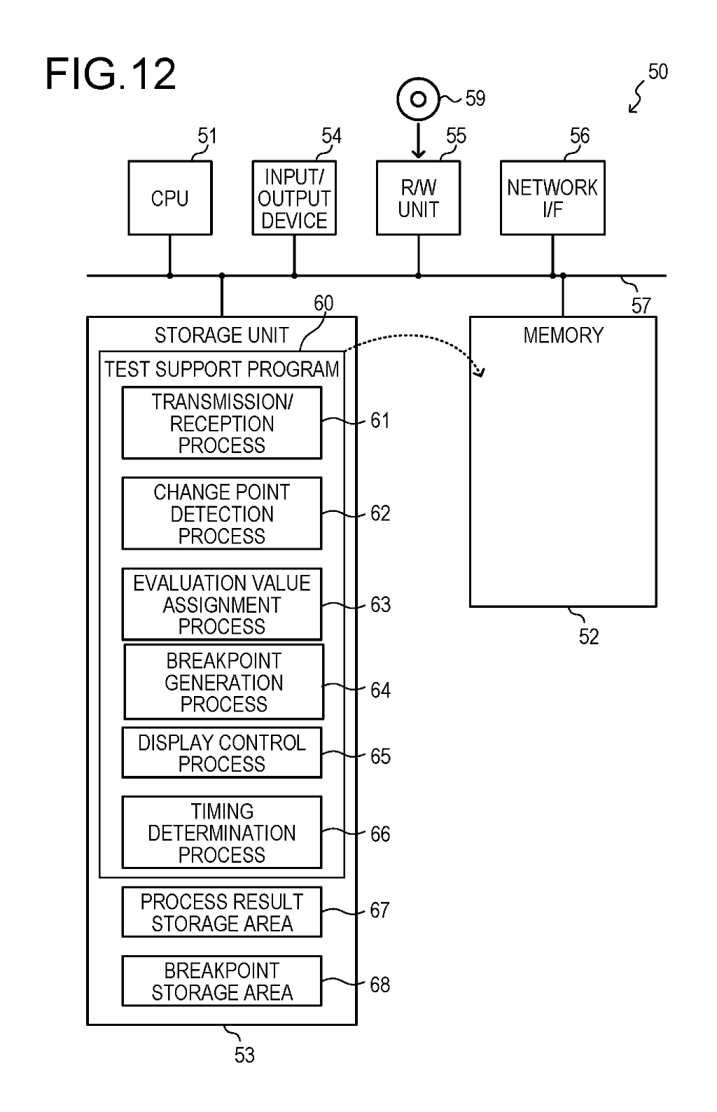

The controller 20 of the test support device 12 may be implemented with, for example, a computer 50 illustrated in FIG. 12. The computer 50 includes a CPU 51, a memory 52 which is a temporary storage area, and a nonvolatile storage unit 53. Further, the computer 50 includes an input/output device 54 such as a display device and input device, and a read/write (R/W) unit 55 that controls data reading and writing in a storage medium 59. Further, the computer 50 includes a network interface (I/F) 56 coupled to a network such as the Internet. The CPU 51, the memory 52, the storage unit 53, the input/output device 54, the R/W unit 55, and the network I/F 56 are coupled to each other via a bus 57.

The storage unit 53 may be implemented by, for example, a hard disk drive (HDD), a solid state drive (SSD), or a flash memory. As a storage medium, the storage unit 53 stores therein a test support program 60 which causes the computer 50 to function as the controller 20 of the test support device 12. The test support program 60 has a transmission/reception process 61, a change point detection process 62, an evaluation value assignment process 63, a breakpoint generation process 64, a display control process 65, and a timing determination process 66. Further, the storage unit 53 includes a process result storage area 67 that stores information constituting the process result storage unit 24, and a breakpoint storage area 68 that stores information constituting the breakpoint storage unit 32.

The CPU 51 reads the test support program 60 from the storage unit 53 to load the program in the memory 52, and sequentially executes the processes included in the test support program 60. When executing the transmission/reception process 61, the CPU 51 operates as the transmission/reception unit 22 illustrated in FIG. 4. When executing the change point detection process 62, the CPU 51 operates as the change point detector 26 illustrated in FIG. 4. When executing the evaluation value assignment process 63, the CPU 51 operates as the evaluation value assignment unit 28 illustrated in FIG. 4. When executing the breakpoint generation process 64, the CPU 51 operates as the breakpoint generator 30 illustrated in FIG. 4. When executing the display control process 65, the CPU 51 operates as the display controller 34 illustrated in FIG. 4. When executing the timing determination process 66, the CPU 51 operates as the timing determination unit 36 illustrated in FIG. 4. In addition, the CPU 51 reads information from the process result storage area 67 so as to load the process result storage unit 24 in the memory 52. Further, the CPU 51 reads information from the breakpoint storage area 68 so as to load the breakpoint storage unit 32 in the memory 52. Accordingly, the computer 50 that executes the test support program 60 functions as the controller 20 of the test support device 12.

The functions implemented by the test support program 60 may be implemented by, for example, a semiconductor integrated circuit, more specifically, an application specific integrated circuit (ASIC).

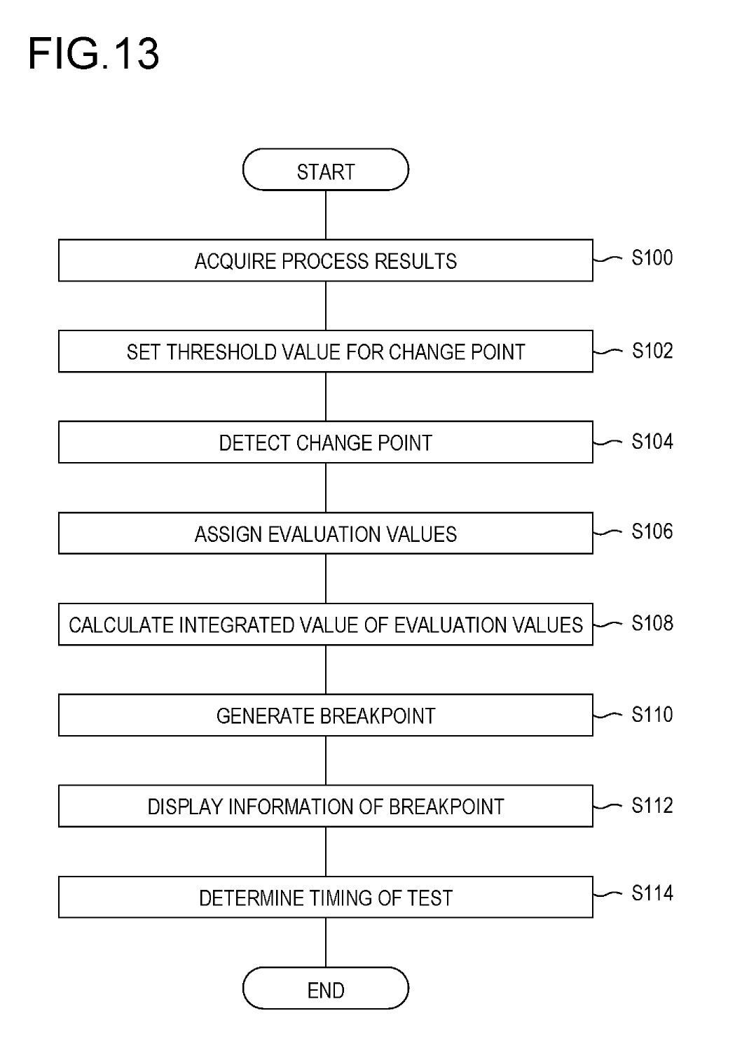

Next, the operation of the test support device 12 according to the present embodiment will be described. For example, in the test support system 100, the test support device 12 causes the information processing system 10 to execute the test target program, and the transmission/reception unit 22 receives the plurality of types of process results from the information processing system 10. Next, the transmission/reception unit 22 sequentially records, in the process result table 41 stored in the process result storage unit 24, each of the plurality of types of process results in association with a timing. Then, in the test support device 12, a test support process illustrated in FIG. 13 is executed. Hereinafter, the test support process will be described.

In S100, the change point detector 26 acquires the process results stored in the process result storage unit 24.

In S102, among the process results acquired in S100, the change point detector 26 sets a change rate of performance information at an occurrence timing of an event on process contents, as a threshold value of a change point related to an event on performances.

In S104, for an event on process contents, the change point detector 26 detects the occurrence timing of the corresponding event as a change point related to an event on process contents.

For an event on performances, on the basis of each value of performance information included in the process results stored in the process result storage unit 24, the change point detector 26 regards that an event on performances occurs when a change rate of performance information is equal to or more than the threshold value set in S102. Then, the change point detector 26 detects the occurrence timing of the event on performances as a change point related to an event on performances.

In S106, based on the events corresponding to the change points detected in S104, the evaluation value assignment unit 28 assigns a preset evaluation value to each of the change points according to the type of events.

In S108, the breakpoint generator 30 integrates the change points within a predetermined time period, based on the timings corresponding to the change points detected in S104. Then, the breakpoint generator 30 generates an integrated value corresponding to the time period on the basis of the evaluation values assigned to the respective change points in S106 and associates the integrated value with a representative timing within the time period.

In S110, for each of the plurality of levels for a process breakpoint, the breakpoint generator 30 generates a process breakpoint of the test target program on the basis of the generated integrated value and the relevant level. Then, the breakpoint generator 30 stores the levels for a process breakpoint and the breakpoints generated according to the respective levels in association with each other in the breakpoint storage unit 32.

In S112, the display controller 34 causes the display unit 40 to display information representing the breakpoints stored in the breakpoint storage unit 32 in S110, in association with information representing the elapsed time after the start of the process of the test target program.

In S114, the timing determination unit 36 subdivides the process of the test target program into a plurality of blocks on the basis of the process breakpoints stored in the breakpoint storage unit 32 in S110. Then, the timing determination unit 36 determines a timing for performing a test for each of the plurality of blocks, according to start and end timings of the process in the corresponding block. Then, the timing determination unit 36 causes the display unit 40 to display the information representing the timings for performing a test associated with the information representing the elapsed time after the start of the process of the test target program, thereafter, the test support process is ended.

As described above, the test support device according to the present embodiment detects a plurality of types of events occurring in the process of the test target program. The test support device assigns an evaluation value predetermined depending on a type of events, to each of the detected events. The test support device integrates the evaluation values assigned to the respective events in each time period so as to generate an integrated value corresponding to the time period. Then, the test support device generates a process breakpoint of the test target program on the basis of the generated integrated value. Accordingly, the number of executions of the timing test may be reduced, as compared with a case where all change points are generated as process breakpoints. That is, with the test support device according to the present embodiment, the timing test may be effectively performed.

The test support device according to the present embodiment integrates the evaluation values assigned to the respective events in each time period so as to generate an integrated value corresponding to the time period. Then, the test support device generates a process breakpoint of the test target program on the basis of the integrated value. Therefore, the number of executions for the timing test may be reduced.

The test support device according to the present embodiment displays the breakpoints generated depending on the plurality of levels for a process breakpoint, in association with information representing the elapsed time after the start of the process of the test target program. Accordingly, the test person may check the process breakpoints corresponding to the plurality of levels. Therefore, even a test person having no specific knowledge of the test target system may effectively perform the timing test based on the process breakpoints obtained by the test support device.

The test support device according to the present embodiment displays a breakpoint generated for a selected level in association with information representing the elapsed time after the start of the process of the test target program. Therefore, the test person may check the breakpoint corresponding to the selected level.

The test support device according to the present embodiment subdivides the process of the test target program into a plurality of blocks on the basis of the generated process breakpoints. For each of the plurality of blocks, the test support device according to the present embodiment determines a timing for performing a process different from the process of the test target program, depending on the start and end timings of the process in the corresponding block. Since a timing for performing the timing test is determined in this manner, the timing test based on a process breakpoint may be effectively performed.

Each of the breakpoints obtained by the test support device according to the present embodiment is based on the results of the execution of the test target program. Thus, by performing the timing test using the obtained breakpoints, the reliability of the timing test may be maintained, and the test time may be reduced.

In the above description, the test support program 60 is stored (installed) in advance in the storage unit 53. However, embodiments are not limited thereto. The program according to the present embodiment may be provided in a form recorded in a recording medium such as a compact disc read-only memory (CD-ROM), a digital versatile disc read-only memory (DVD-ROM), or a universal serial bus (USB) memory.

Next, modifications of the present embodiment will be described.

In the present embodiment, descriptions have been made on the example where the events on process contents are the message and the file presence/absence, and the events on performances are changes in the CPU usage rate, the memory usage rate, and the number of disk IOs which are equal to or more than threshold values. However, embodiments are not limited thereto. A change point may be detected by using other events.

In the present embodiment, the example where the information processing system 10 and the test support device 12 are separate devices has been described. However, embodiments are not limited thereto. For example, the test support device may execute the program to be subject to the timing test and generate a process breakpoint.

In the exemplary process of generating an integrated value in the present embodiment, the predetermined time period is assumed to be 3 seconds, locations where a plurality of change points are present between t (second) and t+1 (second) are detected, and evaluation values corresponding to t (second), t+1 (second), and t+2 (second) are integrated. However, embodiments are not limited thereto. Another process may be used as long as the process integrates evaluation values assigned to a plurality of change points to generate an integrated value corresponding to the time period.

In the present embodiment, it is described that the breakpoint generator 30 may generate, as a breakpoint, a change point related to an integrated value which is equal to or more than a value set as a level selected by a user from the plurality of levels for a process breakpoint. However, the method for selecting the level is not limited thereto. For example, based on a level selected in accordance with another process, a change point related to an integrated value which is equal to or more than a value set as the relevant level may be generated as a breakpoint.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment of the present disclosure has been described in detail, it should be understood that the various changes, substitutions, and alterations could be made hereto without departing from the spirit and scope of the disclosure.

What is claimed is:

1. A non-transitory computer-readable recording medium having stored therein a test support program that causes a computer to execute a test support process, the test support process comprising:
acquiring event information on events which occur during an execution of a target program to be tested;
classifying the events into event groups on basis of similarity of timings at which the respective events occur;
calculating, for each of the event groups, a summed value of evaluation values of the respective events classified into the relevant event group;
determining for each of the event groups, on basis of the summed value, whether a breakpoint of a target process is present at a timing corresponding to the relevant event group, the target process being executed by the target program; and
displaying timing information indicating a timing at which a breakpoint is determined to be present, in association with elapsed time after a start of executing the target program.

2. The non-transitory computer-readable recording medium according to claim 1, the test support process comprising:
performing the determination, for each of preset levels, on basis of the summed value and the relevant level.

3. The non-transitory computer-readable recording medium according to claim 1, the test support process comprising:
performing the determination, for a level selected from among preset levels, on basis of the summed value and the selected level.

4. The non-transitory computer-readable recording medium according to claim 1, the test support process comprising:
subdividing, on basis of the timing information, the target process into blocks; and
determining, for each of the blocks, a timing for performing a test process different from the target process, on basis of timings of starting and ending a sub-process corresponding to the relevant block.

5. The non-transitory computer-readable recording medium according to claim 1, the test support process comprising:
determining, for each of the events, whether the relevant event is a change point, the change point being a candidate for a breakpoint; and
assigning an evaluation value to respective events determined to be a change point, the evaluation value being preset for the respective events.

6. The non-transitory computer-readable recording medium according to claim 5, the test support process comprising:
determining that a first event is a change point when the first event is an event on process contents of the target program; and
determining that a second event is a change point when the second event is an event on performances of a system which executes the target program and when a change rate of the second event is larger than a threshold value, the change rate being a rate of changing in a value of a performance, the threshold value being preset on basis of a change rate of the second event at a timing at which an event on process contents occurs.

7. A test support device, comprising:
a memory; and
a processor coupled to the memory and the processor configured to:
acquire event information on events which occur during an execution of a target program to be tested;
classify the events into event groups on basis of similarity of timings at which the respective events occur;
calculate, for each of the event groups, a summed value of evaluation values of the respective events classified into the relevant event group;
determine for each of the event groups, on basis of the summed value, whether a breakpoint of a target process is present at a timing corresponding to the relevant event group, the target process being executed by the target program; and
display timing information indicating a timing at which a breakpoint is determined to be present, in association with elapsed time after a start of executing the target program.

8. The test support device according to claim 7, wherein
the processor is configured to:
perform the determination, for each of preset levels, on basis of the summed value and the relevant level.

9. The test support device according to claim 7, wherein
the processor is configured to:
perform the determination, for a level selected from among preset levels, on basis of the summed value and the selected level.

10. The test support device according to claim 7, wherein
the processor is configured to:
subdivide, on basis of the timing information, the target process into blocks; and
determine, for each of the blocks, a timing for performing a test process different from the target process, on basis of timings of starting and ending a sub-process corresponding to the relevant block.

11. The test support device according to claim 7, wherein
the processor is configured to:
determine, for each of the events, whether the relevant event is a change point, the change point being a candidate for a breakpoint; and
assign an evaluation value to respective events determined to be a change point, the evaluation value being preset for the respective events.

12. The test support device according to claim 11, wherein
the processor is configured to:
determine that a first event is a change point when the first event is an event on process contents of the target program; and
determine that a second event is a change point when the second event is an event on performances of a system which executes the target program and when a change rate of the second event is larger than a threshold value, the change rate being a rate of changing in a value of a performance, the threshold value being preset on basis of a change rate of the second event at a timing at which an event on process contents occurs.

13. A test support method, comprising:
acquiring, by a computer, event information on events which occur during an execution of a target program to be tested;
classifying the events into event groups on basis of similarity of timings at which the respective events occur;
calculating, for each of the event groups, a summed value of evaluation values of the respective events classified into the relevant event group;
determining for each of the event groups, on basis of the summed value, whether a breakpoint of a target process is present at a timing corresponding to the relevant event group, the target process being executed by the target program; and
displaying timing information indicating a timing at which a breakpoint is determined to be present, in association with elapsed time after a start of executing the target program.

14. The test support method according to claim 13, comprising:
performing the determination, for each of preset levels, on basis of the summed value and the relevant level.

15. The test support method according to claim 13, comprising:
performing the determination, for a level selected from among preset levels, on basis of the summed value and the selected level.

16. The test support method according to claim 13, comprising:
subdividing, on basis of the timing information, the target process into blocks; and
determining, for each of the blocks, a timing for performing a test process different from the target process, on basis of timings of starting and ending a sub-process corresponding to the relevant block.

17. The test support method according to claim 13, comprising:
determining, for each of the events, whether the relevant event is a change point, the change point being a candidate for a breakpoint; and
assigning an evaluation value to respective events determined to be a change point, the evaluation value being preset for the respective events.

18. The test support method according to claim 17, comprising:
determining that a first event is a change point when the first event is an event on process contents of the target program; and
determining that a second event is a change point when the second event is an event on performances of a system which executes the target program and when a change rate of the second event is larger than a threshold value, the change rate being a rate of changing in a value of a performance, the threshold value being preset on basis of a change rate of the second event at a timing at which an event on process contents occurs.
